(19) United States
(12) Patent Application Publication
(10) Pub. No.: US 2003/0224523 A1
(43) Pub. Date: Dec. 4, 2003

(54) Cartridge arrangement, fluid analyzer arrangement, and methods

(76) Inventors: John Herbert Thornberg, Roseville, MN (US); Kee Van Sin, Lino Lakes, MN (US); Martin Gaines Hieb, Plymouth, MN (US); Ronald William Sand, Lakeville, MN (US); Scott Everett Blomberg, Plymouth, MN (US)

Correspondence Address: Julie R. Daulton, Merchant & Gould P.C., P.O. Box 2903, Minneapolis, MN, 55402-0903, US

(21) Appl. No.: 10/160,329

(22) Filed: May 30, 2002

(51) Int. Cl. G01N 35/00

(52) U.S. Cl. 436/43; 422/58; 422/63

(57) ABSTRACT

A cartridge for analysis of fluid samples useable with an analyzer device includes an arrangement to selectively control fluid flow within the cartridge. One type of cartridge includes a fluid channel. A sensor arrangement is oriented within the fluid channel and includes at least one dry-stored sensor and at least one wet-stored sensor. The cartridge may include a first port. In some instances, the cartridge can include a second port. In some instances, the cartridge can include a third port. In some implementations, a cartridge includes a fluid reservoir in fluid communication with a port on the cartridge. The fluid reservoir defines a fluid passage and a fluid dispenser actuator. The actuator includes an over-center engageable button depressible to initiate fluid flow from an internal volume in the fluid reservoir and through the fluid passage and through the port into the sensor arrangement on the cartridge. Methods for analyzing, calibrating, and using the cartridge are provided.

### TECHNICAL FIELD

This disclosure describes cartridges for analysis of fluid samples, wherein the cartridge is for use with an analyzer device. In specific applications, this disclosure describes cartridges, arrangements, and methods for analyzing blood including, for example, blood gases, blood electrolytes, glucose, blood urea nitrogen, and creatinine.

This disclosure is an on-going development of Diametrics Medical, Inc., the assignee of this disclosure. This disclosure concerns continuing developments related, in part, to the subject matter characterized in U.S. Pat. Nos. 5,325,853; 6,066,243; 5,384,031; 5,223,433; 6,060,319; and 5,232,667. Each of the patents identified in the previous sentence is also owned by Diametrics Medical, Inc., and the complete disclosure of each is incorporated herein by reference.

### BACKGROUND

Blood gas determinations, including the partial pressures of oxygen (pO₂), carbon dioxide (pCO₂), acidity or alkalinity (pH), and concentration of certain electrolyte species such as potassium (K⁺) in the blood are examples of measurements useful for diagnosis. It can be particularly useful to have quick blood analysis (e.g., within a few minutes of withdrawing blood from the patient) in order to diagnose and treat the patient.

Improvements in blood analysis technology are desirable.

### SUMMARY

A cartridge for analysis of fluid samples useable with an analyzer device is provided. The cartridge includes an arrangement to selectively control fluid flow within the cartridge.

One type of cartridge includes a fluid channel. A sensor arrangement is oriented within the fluid channel and includes at least one dry-stored sensor and at least one wet-stored sensor. The cartridge may include a first port. In some instances, the cartridge can include a second port. In some instances, the cartridge can include a third port.

In some implementations, a cartridge includes a fluid reservoir in fluid communication with a port on the cartridge. The fluid reservoir defines a fluid passage and a fluid dispenser actuator. The actuator includes an over-center engageable button depressible to initiate fluid flow from an internal volume in the fluid reservoir and through the fluid passage and through the port into the sensor arrangement on the cartridge.

Methods for analyzing fluid samples, calibrating sensors, and using cartridges are provided.

### BRIEF DESCRIPTION OF THE DRAWINGS

FIG. 1 is a schematic depicting a general environment of use utilizing principles of this disclosure;

FIG. 2 is a perspective view of a cartridge and an analyzer device constructed according to principles of this disclosure;

FIG. 3 is a schematic, top plan view of the cartridge depicted in FIG. 2, and constructed according to principles of this disclosure;

FIG. 4 is a schematic, side elevational view of the cartridge of FIG. 3, and including a syringe mounted thereon;

FIG. 5 is a schematic view of a fluid channel and valve arrangement used in the cartridge of FIGS. 2 and 3, each of the valves in the valve arrangement being in a closed position;

FIG. 6 is a view similar to FIG. 5, and showing one of the valves in an open position and another of the valves in a closed position;

FIG. 7 is a view similar to FIGS. 5 and 6, but showing a different state of the valve arrangements;

FIG. 8 is a schematic, cross-sectional view of a fluid reservoir having a fluid dispenser actuator, utilized in a preferred embodiment of the cartridge of FIGS. 2 and 3;

FIG. 9 is a view similar to FIG. 8, but showing the actuator in a depressed position;

FIG. 10 is a perspective view of a base structure of the fluid reservoir depicted in FIGS. 8 and 9;

FIG. 11 is a top plan view of the base structure depicted in FIG. 10;

FIG. 12 is a cross-sectional view of the base structure, the cross-section being taken along the line 12-12 of FIG. 11;

FIG. 13 is a top plan view of a lid for the fluid reservoir of FIGS. 8 and 9, the lid being mountable on the base structure of FIGS. 10-12; and

FIG. 14 is a cross-sectional view of the lid of FIG. 13, the cross-section being taken along the line 14-14 of FIG. 13.

### DETAILED DESCRIPTION

### A. Environment of Use and General Overview

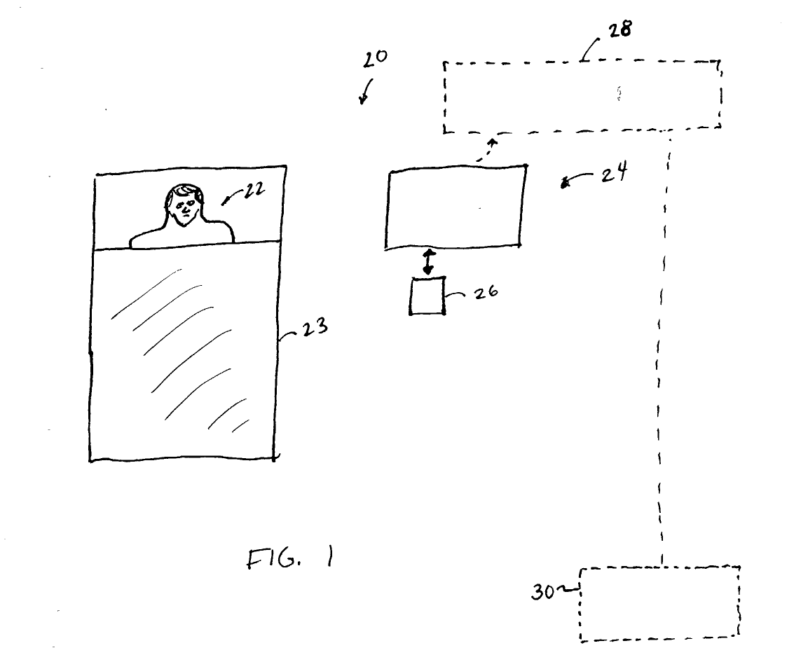

FIG. 1 depicts one example of an environment of use for the principles described in this disclosure. In FIG. 1, there is a medical treatment system at 20. A patient 22 is shown lying in a bed 23 adjacent to an analyzer device 24. The medical treatment system 20 may be in, for example, a hospital room, an operating room, or other patient treatment facilities. The analyzer device 24 is useable for determining characteristics of fluid samples from the patient 22. For example, body fluid including, e.g. blood, may be drawn from the patient 22 and analyzed bedside by the analyzer device 24 to obtain characterization information. The analyzer device 24 can analyze the fluid sample to determine, for example, oxygen content, creatinine content, blood urea nitrogen (BUN) content, glucose content, sodium content, acidity (pH), carbon dioxide content, calcium content, potassium content, hematocrit content, chloride content, lactate content, coagulation, and other desired information, depending upon the particular application.

The fluid sample is drawn from the patient 22 and placed into a container or cartridge 26. The cartridge 26 is then oriented within the analyzer device 24, which analyzes the fluid sample, and the results are provided to the caregiver. This “point of care” diagnostic fluid testing reduces turn-around time, improves clinical protocols and staff efficiency, and contributes to improved patient outcomes when compared to existing prior art systems. Such prior art systems include hospital laboratory equipment that is permanently installed.

In certain applications, the analyzer device 24 includes a blood analysis system as described in U.S. Pat. No. 6,066,243, incorporated herein by reference. One type of useable analyzer device 24 is commercially available from Diametrics Medical Inc., Roseville, Minn., under the brand name IRMA Blood Analysis System.

In some applications, the analyzer device 24 is insertable into or otherwise connected to a patient monitor 28, depicted in phantom lines. The monitor can be, for example, a Philips CMS and V24/V26 hospital monitor system. Monitor 28 is integrated with other information from the patient 22 in a main database 30. In this type of application, the analyzer device 24 is a blood analysis system compatible with plugging into a hospital monitor 28, such as the system commercially available from Diametrics Medical under the brand name PORTAL.

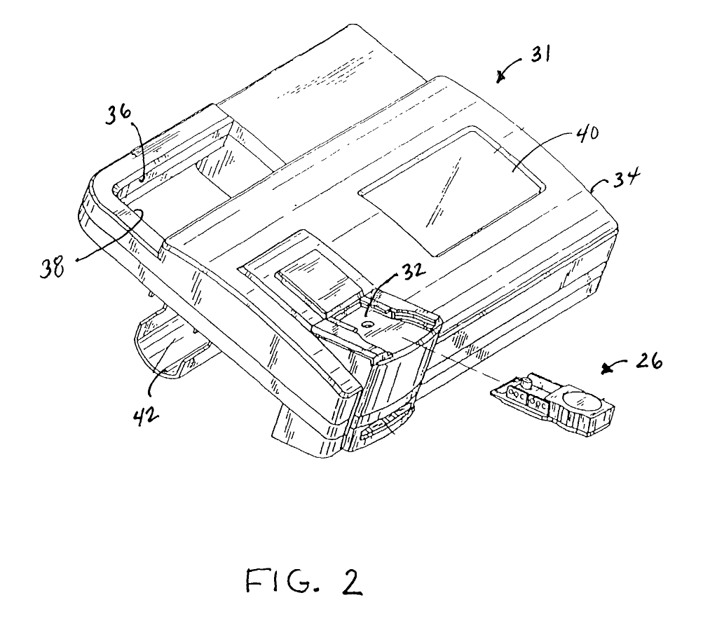

In FIG. 2, there is a perspective view of an analyzer device 31 and cartridge 26. In FIG. 2, cartridge 26 is shown removed from analyzer device 31. The cartridge 26 is pluggable or insertable into the analyzer device 31 at the cartridge receiving area 32. The analyzer device 31 includes an external housing 34, which, in the particular one depicted in FIG. 2, forms a carrying handle 36. The handle 36 defines an opening 38 sized for receipt of a human hand, contributing to the portable nature of the analyzer device 31. The analyzer device 31 usually will weigh less than 50 lbs, and typically less than 25 lbs, also contributing to portability. In the one shown, the analyzer device 31 includes an output display 40 and a battery case 42. In some instances, the device 31 can include a printer system (not shown).

### B. Some Problems With Existing Systems

To determine characteristics of a fluid utilizing principles of this disclosure, selected sensors are utilized to measure the characteristic of interest. Sensors come in various types. For electrochemical sensors, typical types of sensors used are: ion selective electrode (potentiometric) sensors; amperometric sensors; conductometric sensors; and enzymatic sensors.

If the fluid sample is blood, for example, for measuring blood gases, typical useable constructions may include ion selective electrode sensors to measure pH and pCO₂. One type of pO₂ sensor may be an amperometric sensor. For blood electrolytes, for example, sodium (Na⁺) sensors, calcium (iCa⁺⁺) sensors, and potassium (K⁺) sensors can be ion selective electrode sensors. Hematocrit may be measured using, for example, a conductometric sensor. Chloride may be measured, in many typical implementations, with an ion selective electrode sensor. Glucose, blood urea nitrogen (BUN), and creatinine may be measured utilizing, for example, enzymatic sensors. To measure blood coagulation, one type of sensor useable may be a conductometric sensor.

In order to obtain an accurate measurement, in some instances, selected ones of the sensors should be calibrated. U.S. Pat. No. 5,325,853, incorporated by reference herein, describes systems and methods for calibrating certain of these types of sensors. The calibration systems described in the '853 patent utilize a gel stabilized dispersion or solution of aqueous and/or non-aqueous calibration material. In such systems and methods in the '853 patent, the calibration gel is stored over the sensors until the cartridge is used for analyzing the fluid sample. Typically, the calibration gel is placed over the sensors in the manufacturing facility, and after calibration by the user by inserting the cartridge into analyzer device 24, the gel is pushed aside into a waste chamber to make room for the fluid, in this case, blood.

Certain types of calibration problems may be encountered when enzymatic sensors have calibrant stored thereon. For example, in some methods, the presence of the enzymes within the sensor membranes will deplete the analytes within the calibrant gel and thereby change the concentration of the analyte within the calibrant.

It is desirable to store certain sensor types before use in either a solution (“wet-stored”) or not in a solution (“dry-stored”). When more than one sensor type is desired within a single cartridge, and certain of the sensors are to be wet-stored, while certain of the sensors are to be dry-stored, there can be complications.

Thus, systems and methods for calibrating selected ones of the sensors contained within a single cartridge, no matter what the type of calibration method (for example, with a liquid calibrant or not with a liquid calibrant) are useful. A cartridge that can accommodate a variety of sensors, regardless of the storage requirement (wet or dry) and regardless of the way it is calibrated is useful. Further, it is useful to have a cartridge that is easy to manufacture due to a non-complex flow channel and that can perform most of its sensing by utilizing just a single fluid sample injection therein.

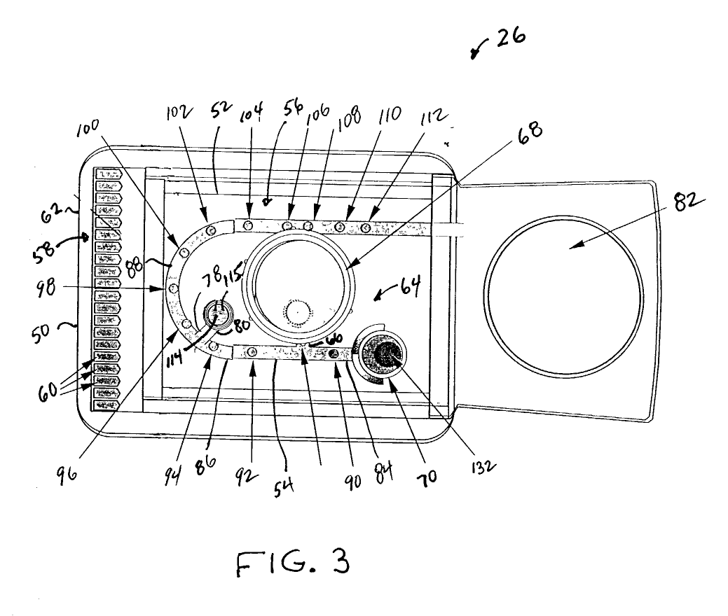

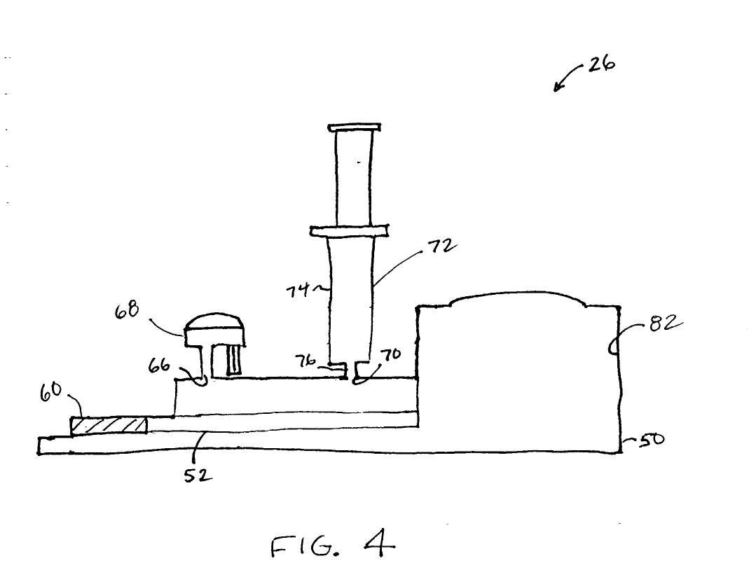

### C. Example Cartridges, FIGS. 3 and 4

FIG. 3 illustrates, schematically, a plan view of one example cartridge 26. The cartridge 26 includes a base structure 50, preferably constructed of a polymer material such as a polycarbonate. The base structure 50 holds or is a housing for a substrate 52. In preferred applications, the substrate 52 is a ceramic substrate.

The base structure 50 defines at least one fluid channel 54, which accommodates a sensor arrangement 56 therein. By “sensor arrangement”, it is meant at least one sensor or a plurality of sensors is contained within the fluid channel 54. The sensors within the sensor arrangement 56 can be any of the sensor types discussed above, including, for example, wet-stored, dry-stored, liquid-calibrated, non-liquid calibrated, or not calibrated at all. In some systems, there may be additional sensor types within the sensor arrangement 56.

The cartridge 26 further includes a conductor arrangement 58 in electrical contact with the sensor arrangement 56. The conductor arrangement 58, in the one shown, includes an array of functional electrical conductors 60. The conductors 60 allow for electrical communication between the cartridge 26 and the analyzer device 24, and include input and output conductors. The conductors 60 are constructed in accordance with conventional techniques. In the example shown, they are deposited on the surface of the substrate 52. As can be seen in FIGS. 3 and 4, the conductors 60 are adjacent to an edge 62 of the cartridge 26, allowing the cartridge 26 to be adaptable in use with edge connectors.

The cartridge 26 includes a port arrangement 64 in fluid communication with the fluid channel 54. The port arrangement 64 allows for selective insertion of selected fluids into the fluid channel 54. In the example shown in FIG. 3, the port arrangement includes at least a first port 66 that provides fluid communication between a first fluid reservoir 68 and the fluid channel 54. In preferred systems, there will also be an arrangement to prevent fluid from flowing from the fluid channel 54 through the first port 66 in a direction toward the first fluid reservoir 68.

The port arrangement 64 may further include, and does so in the one depicted, a second port 70. The second port 70 allows for fluid communication between a second fluid reservoir 72 (FIG. 4) and the fluid channel 54. In the particular one shown in FIG. 4, the second fluid reservoir 72 is a syringe 74, which can have a luer lock 76 for a reliable connection between the syringe 74 and the cartridge 26. In certain systems, there may be an optional locking arrangement to prevent fluids from flowing from the fluid channel 54 back through the second port 70 toward the second fluid reservoir 72.

Depending upon the types of sensors desired in the sensor arrangement 56, the port arrangement 64 may also include a third port 78. The third port 78 allows for fluid flow from a duct 80 into the fluid channel 54. There may also be an optional arrangement to prevent fluid from flowing from the fluid channel 54 back through the third port 78 and through the duct 80 (explained below in connection with a septum 114). Note that the third port 78 is not viewable in the side view of FIG. 4, but can be seen from the top view of FIG. 3.

The cartridge 26 shown further includes a waste chamber 82 in fluid communication with the fluid channel 54. In use, the waste chamber 82 collects and contains used fluids in the cartridge 26. Such used fluids include, for example, used calibration fluid and bodily fluid, such as blood.

As described above, the sensor arrangement 56 can include just one sensor, or a plurality of sensors. Further, the sensor arrangement 56 can include different types of sensors including ion selective electrode sensors, amperometric sensors, conductometric sensors, and enzymatic sensors. The sensor arrangement 56 can include sensors that are calibrated by being covered with calibration liquid or sensors calibrated by other methods that do not involve calibration liquid. The sensor arrangement 56 can include sensors that are both wet-stored and dry-stored. By “wet-stored”, it is meant the sensor is covered with a solution (typically aqueous) in storage before use. By “dry-stored”, it is meant the sensor is not covered by a liquid solution in storage before use. A “dry-stored” sensor can also include a sensor that is not covered by a liquid solution in storage before use and that is stored in a humid environment (i.e., there is vapor in contact with the dry-stored sensor). The particular example shown in FIG. 3 includes sensor arrangement 56 having each of these various types. The sensors in the sensor arrangement 56 are arranged relative to the first port 66, second port 70, and third port 78 based upon the type of sensor and/or whether it is wet-stored or dry-stored. This arrangement is discussed further below.

In the example shown in FIG. 3, the first fluid reservoir 68 contains calibration fluid therein. The calibration fluid is a fluid selected appropriate for the types of sensors in the sensor arrangement 56. Typical calibration fluid useable will be an aqueous solution with the appropriate amount of test materials. That is, for each of the sensors in the sensor arrangement 56, there will be a material in the calibration fluid to allow for a test measurement. During calibration, the calibration material flows into the fluid channel 54 and contacts the sensor arrangement 56. Selected ones of the sensors in the sensor arrangement 56 are then calibrated based upon the known quantity of material in the calibration fluid.

In the cartridge 26 depicted, the second fluid reservoir 72 (FIG. 4) contains the fluid sample for analysis. For example, this fluid sample is body fluid, such as blood. In alternate embodiments, the second fluid reservoir 72 may be put in fluid communication with the first port 66, interchangeably with the first fluid reservoir 68. In this alternate embodiment, the second port 70 may be omitted from the cartridge 26. This alternate embodiment would accommodate both dry-stored sensors and sensors calibrated with calibration fluid from the first fluid reservoir 68.

In typical operation, calibration fluid is first dispensed from the first fluid reservoir 68. From the first fluid reservoir 68, the calibration fluid flows through the first port 66, into the fluid channel 54, over the sensor arrangement 56, and then into the waste chamber 82. In the example shown, the calibration fluid is not allowed to flow from the first port 66 in a direction toward the second port 70. This is due to back pressures created during the manufacturing process (i.e., an air pocket between the first port 66 and second port 70). Also, during typical operation, the fluid sample, for example blood, is dispensed from the second fluid reservoir 72 and flows through the second port 70 into the fluid channel 54, over the sensor arrangement 56 and then into the waste chamber 82. The fluid sample, in this example, is not allowed to flow from the second port 70 through the first port 66 due to a blocking arrangement. One example blocking arrangement is described further below, in Section D.

The fluid channel 54, in the one depicted in FIG. 3, has three sections. The first section 84 is downstream of the second port 70 and upstream of the first port 66. The first section is generally between the second port 70 and the first port 66. The first section 84 is for housing sensors that do not utilize fluid from the first fluid reservoir 68. The first section 84 is also for accommodating sensors that use dry storage.

A second section 86 of the fluid channel 54 is between the second port 70 and the third port 78. Preferably, the second section 86 is downstream of the first port 66 and the second port 70 and upstream from the third port 78. The second section 86 accommodates sensors that utilize the calibration fluid from the first fluid reservoir 68 and that can be dry-stored.

A third section 88 of the fluid channel 54 accommodates sensors that may utilize the fluid from the fluid reservoir 68 and that can be wet-stored. The third section 88 is located between the third port 78 and the waste chamber 82. In the example shown, the third section 88 is located downstream of each of the first port 66, second port 70 and third port 78.

In the embodiment depicted in FIG. 3, the first section 84 of the fluid channel 54 contains an oxygen sensor 90. The oxygen sensor 90 senses the amount of oxygen in the body fluid sample from the second reservoir 72. The oxygen sensor 90, in the one shown, is preferably calibrated by exposure to the ambient air. In particular, the analyzer device 24 contains a barometer that is used to sense the air pressure in the fluid sample, from which is derived the partial pressure and the amount of oxygen content in the fluid sample. The oxygen sensor 90 is located downstream of the second port 70 such that, when appropriate, the fluid sample (e.g., blood or other body fluid) from the second fluid reservoir 72 is allowed to flow over the oxygen sensor 90 in order to take the measurement. The oxygen sensor 90 is located upstream of the first fluid port 66 such that when calibration fluid is dispensed from the first fluid reservoir 68 through the first port 66, the oxygen sensor 90 is allowed to remain liquid-free and dry, and exposed to the air. During manufacturing in some applications, an air pocket is created in the first section 84. In this example, the air pocket in first section 84 prevents the calibration fluid from flowing upstream in a direction from the first fluid port 66 to the second fluid port 70.

Note that in alternate systems, the oxygen sensor 90 may also be calibrated with a perfluorocarbon non-aqueous calibration phase. This is disclosed in commonly assigned U.S. Pat. No. 5,231,030, incorporated herein by reference.

The first section 84 may also include a coagulation sensor. A typical, useable coagulation sensor will be dry-stored. In many applications, calibration of the coagulation sensor is optional.

The second section 86, as described above, is for accommodating sensors that can be dry-stored, but also can use the fluid from the first fluid reservoir 68. While a number of different sensors meet this criteria, in the example shown in FIG. 3, the second section 86 accommodates a creatinine sensor 92, and a blood urea nitrogen (BUN) sensor 94. In general, the sensors in the second section 86 may be enzymatic sensors. In this example, the creatinine sensor 92 and the BUN sensor 94 are arranged for dry storage. The sensors 92, 94 are downstream of the second fluid port 72, so that when the sample is dispensed from the second fluid reservoir 72, it flows over the sensors 92 and 94. The sensors 92 and 94 are also downstream of the first fluid reservoir 68, to allow for the flow of fluid thereover, when the fluid is dispensed from the first fluid reservoir 68. The sensors 92, 94 are upstream of the third port 78, which allows them to be dry-stored. An air pocket is formed with the first section 84 and second section 86 of the fluid channel 54 during the manufacturing process when the storage fluid is dispensed over the third section 88.

The third section 88 of the fluid channel 54 contains sensors in the sensor arrangement 56 that are wet-stored and that can utilize the fluid from the fluid reservoir 68. As such, the sensors in the third section 88 are downstream of each of the first port 66, second port 70, and third port 78. The sensors in the third section 88 can include many different types of sensors including, for example, ion selective electrode sensors, conductometric sensors, and, in some instances, enzymatic sensors. Different types of sensor arrangements can be used within the third section 88, and in the particular example shown, the sensor arrangement 56 in the third section 88 includes, in order from upstream to downstream, starting with the position just downstream of the third port 78: a sodium sensor 96, a chloride sensor 98, a potassium sensor 100, a calcium sensor 102, a lactate sensor 104, a pH sensor 106, a carbon dioxide sensor 108, a hematocrit sensor 110, and a glucose sensor 112.

In typical applications, the selected ones of the sensors in the third section 88 will be wet-stored. A septum 114 in fluid communication with the duct 80 allows for the introduction of storage fluid therewithin in order to flow through the duct 80 and into the third section 88 of the fluid channel 54. One useable type of septum 114 will be a self-sealing gasket 115, receptive to penetration by a needle on a syringe containing storage fluid. The storage fluid is typically hydration fluid that is similar to the calibration fluid contained within the first fluid reservoir 68. One difference between the hydration fluid utilized to store the sensors in the third section 88 and the calibration fluid is that the hydration fluid does not contain the material for the enzymatic sensors. The hydration fluid is typically an aqueous solution with electrolytes, and in some implementations, may include an agent for promoting viscosity. The hydration fluid passes through the septum 114, through the duct 80, through the third port 78, and over selected the sensors in the third section 88, but not over the sensors in the first section 84 and second section 86. An air pocket created during manufacturing in the first section 84 and second section 86 prevents flow of the hydration fluid over the sensors in the first section 84 and second section 86. Typically, there may be some hydration fluid that drains into the waste chamber 82, but the dimension of the channel 54 will keep at least some hydration fluid therewithin and covering the sensors in the third section 88. The self-sealing gasket 115 of the septum 114 typically will prevent fluid from flowing from the fluid channel 54 back through the third port 78 and through the duct 80.

In one type of application, each of the sensors sodium 96, chloride 98, potassium 100, calcium 102, lactate 104, pH 106, and carbon dioxide 108 are ion selective electrode type of sensors. In one example, the sensor hematocrit 110 is a conductometric type of sensor. The glucose sensor 112 is, in one example, an enzymatic sensor. The oxygen sensor 90, in one example, is preferably an amperometric sensor, while the creatinine sensor 92 and BUN sensor 94 are, in selected implementations, enzymatic sensors.

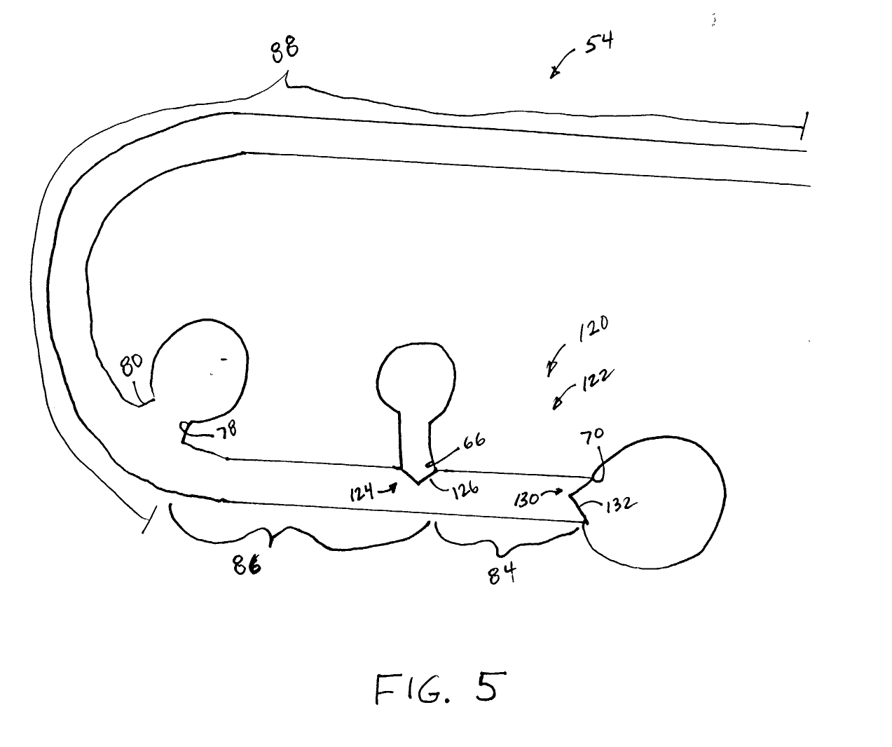

### D. Example Control System, FIGS. 5-7

FIG. 5-7 illustrate, schematically, the fluid channel 54 and a system 120 controlling the direction of fluid flow within the channel 54. In certain applications, it is desirable to use the system 120 to prevent the material flowing through the second port 70 from mixing with the fluid in the first fluid reservoir 68 that flows through the first port 66. For example, in the embodiment illustrated in FIGS. 3 and 4, the system 120 prevents the fluid sample under analysis (for example blood) from mixing with the calibration fluid contained within the first fluid reservoir 68. Such a mixture would contaminate the blood sample with the calibration fluid, and the resulting analysis on the blood sample would be inaccurate. One way of preventing this mixing is to block flow of the fluid sample from the fluid channel 54 into and through the first port 66.

While a number of different ways of implementing this result can be achieved, in the particular example shown in FIG. 5, a valve arrangement 122 is shown. The valve arrangement 122 includes, at least, a first valve 124. The first valve 124 is oriented to selectively block the first port 66 and allow for fluid to flow from the first fluid reservoir 68 through the first fluid port 66 and into the channel 54. The first valve 124 also prevents flow from going backwards; that is, the first valve 124 blocks or prevents fluid from flowing from within the fluid channel 54 back through the first port 66 in a direction toward the first fluid reservoir 68.

In the example shown in FIG. 5, the first valve 124 is a check valve 126. The check valve 126 is shown in FIG. 5 to be in a closed position. The check valve 126 blocks flow from the fluid sample and the second port 70 from flowing in through the first port 66 and mixing with calibration fluid. Preferably, there is an air pocket formed in the first section 84 that prevents calibration fluid from flowing in a direction from the first fluid port 66 toward the second port 70.

In some preferred systems, the valve arrangement 122 may also include an optional second valve 130. The second valve 130 selectively controls fluid flow through the second port 70. The second valve 130 preferably prevents fluid flow from the first fluid reservoir 68 and from the fluid channel 54 to flow through the second port 70 and toward the second fluid reservoir 72. The second valve 130 is optional because, in use, the air pocket created within the first section 84 of the fluid channel 54 should prevent any flow of the calibration fluid from the first fluid reservoir in a direction through the first second 84 toward the second port 70. For cautionary purposes, however, the second valve 130 can be included to insure that the fluid sample in the second fluid reservoir 72 does not mix with the calibration fluid in the first fluid reservoir 68. In the example shown in FIG. 5, the second valve 130 is a check valve 132. The check valve 132 prevents any fluid within the channel 54 from flowing backwards from the channel 54 through the second port 70 and toward the second fluid reservoir 72. In FIG. 5, the second check valve 132 is shown in a closed position.

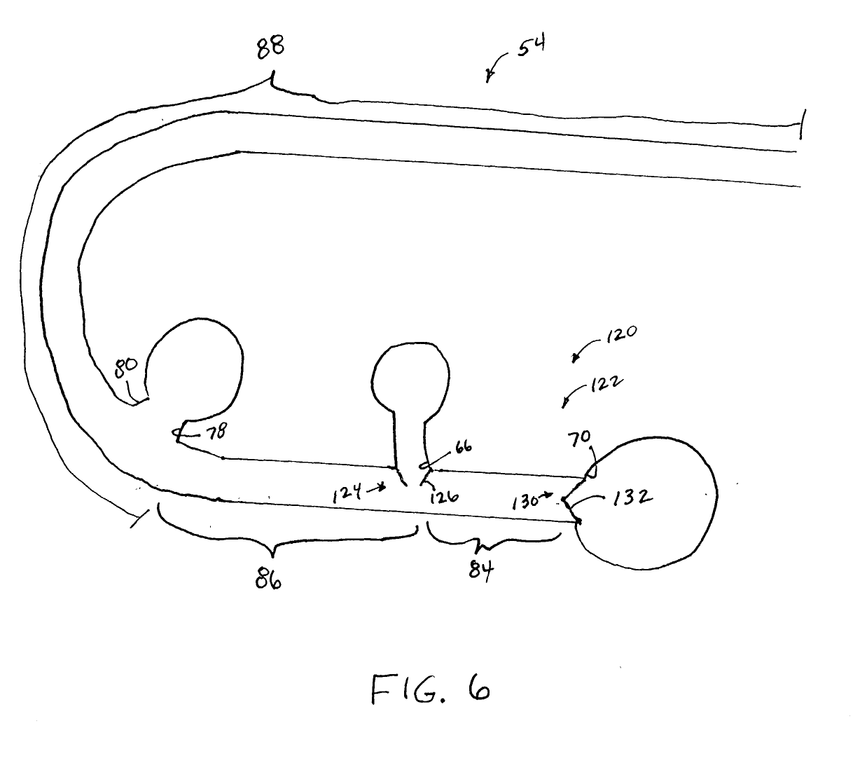

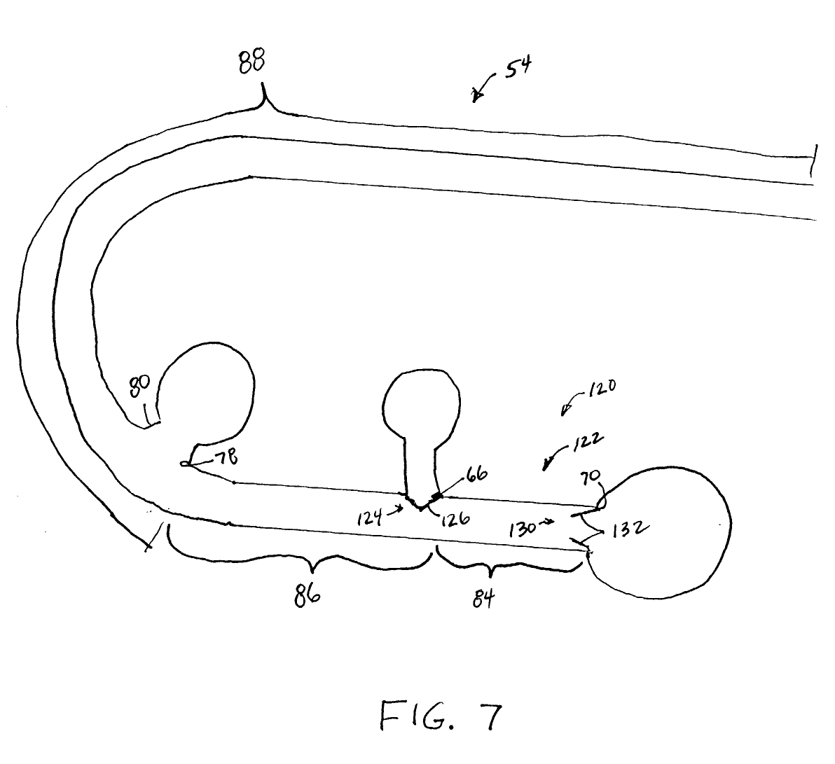

Attention is next directed to FIGS. 6 and 7. In FIG. 6, the first check valve 126 is shown in an open position, while the second check valve 130 is shown in a closed position. FIG. 6 would be the position of the valve arrangement 122 when the calibration fluid is being dispensed from the first fluid reservoir 68, through the first port 66, and into the fluid channel 54. The air pocket in first section 84 and the closed position of the second check valve 132 prevents flow of the calibration fluid toward the second port 70. Instead, the calibration fluid flows across the second section 86 and third section 88 in a direction toward the waste chamber 82 (FIGS. 3 and 4).

FIG. 7 shows the first valve 124 closed and the second valve 130 open. This would be the position of the valve arrangement 122 when the fluid sample is deployed from the second fluid reservoir 72 and across all of the sensors in the sensor arrangement 56. The check valve 132 is open, which allows the fluid sample (e.g., body fluid including blood) to flow from the second fluid reservoir 72 downstream across the first section 84, second section 86, and third section 88 and finally into the waste chamber 82. The check valve 126 is closed to prevent the fluid sample from mixing with the calibration fluid, and to prevent the fluid sample from flowing into the first port 66 toward the first fluid reservoir 68.

FIG. 5 shows both of the first valve 124 and second valve 130 in closed positions. This is the position of the valve arrangement 122 when the cartridge 26 is in storage and is awaiting use.

The check valves 126, 132 can be constructed in a variety of implementations. Examples include rubber flaps, or with the check valve 132, a piece of adhesive tape.

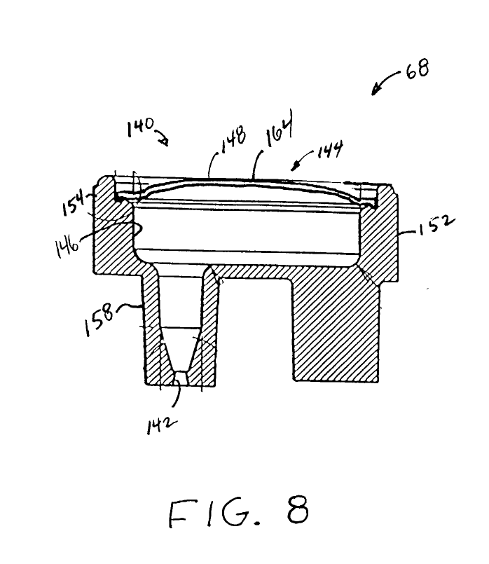

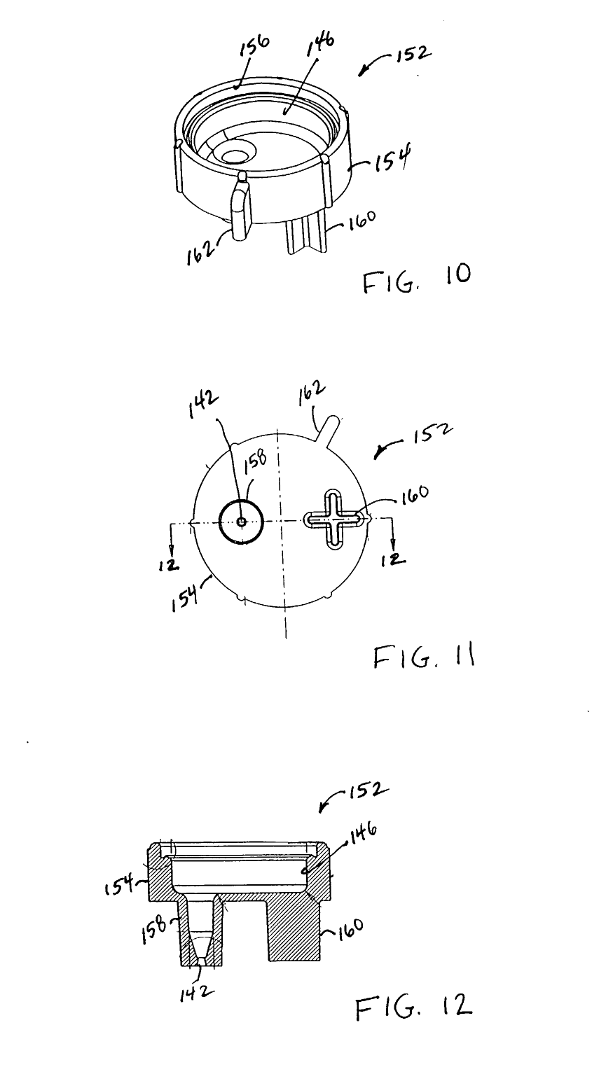

### E. Calibration Dispensing Arrangement, FIGS. 8-14

FIGS. 8 and 9 show a schematic, cross-sectional view of one embodiment of the first fluid reservoir 68. The first fluid reservoir 68 preferably includes a fluid dispensing arrangement 140. The fluid dispensing arrangement 140 allows for convenient and quick dispensing of fluid contained within the fluid reservoir 68 through a fluid passage 142 and in through the first port 66 (FIGS. 3 and 4).

The fluid dispensing arrangement 140 preferably includes an actuator 144 constructed and arranged to initiate fluid flow from the internal volume 146 of the first fluid reservoir 68 and through the fluid passage 142, and ultimately through the first port 66 in the cartridge 26. In the one shown, the actuator 144 is embodied as a push-button 148. The preferred push-button 148 is flexible such that it is over-center engageable. By the term “over-center engageable”, it is meant that once the push-button 148 is pushed a certain distance inward toward a remaining portion of the first fluid reservoir 68, it remains under tension in its actuated position. This is explained further below. In the preferred embodiment illustrated, the over-center engageable button 148 is included as part of a lid 150 that is mountable over a base housing 152. One example of an “over-center engageable” button is a button on the plastic lid of a soft-drink container that can be selectively pushed to indicate the type of beverage contained therein (e.g. “diet”, “tea”, etc.)

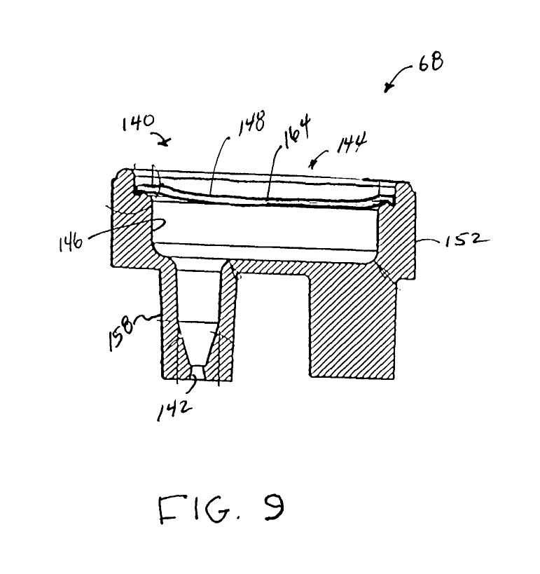

FIGS. 10-12 show the base housing 152 in further detail. The base housing 152 includes an outer wall 154 defining a mouth 156. The mouth 156 is for receiving the lid 150. The wall 154 circumscribes the internal volume 146. The base housing 152 further includes a duct 158, defining the fluid passage 142. Calibration fluid flows from the internal volume 146 through the fluid passage 142 in the duct 158, upon initiation by the push-button 148. The base housing 152 further includes support member 160 to help properly orient and mount the first fluid reservoir 68 onto and relative to the cartridge 26. As can be seen in FIG. 11, in preferred embodiments, the support 160 can be cross-shaped for distributing the force. The base housing 152, in the particular one shown, further includes a handle 162 extending from the wall 154. The handle 162 helps to manipulate the first fluid reservoir 66 relative to the cartridge 26.

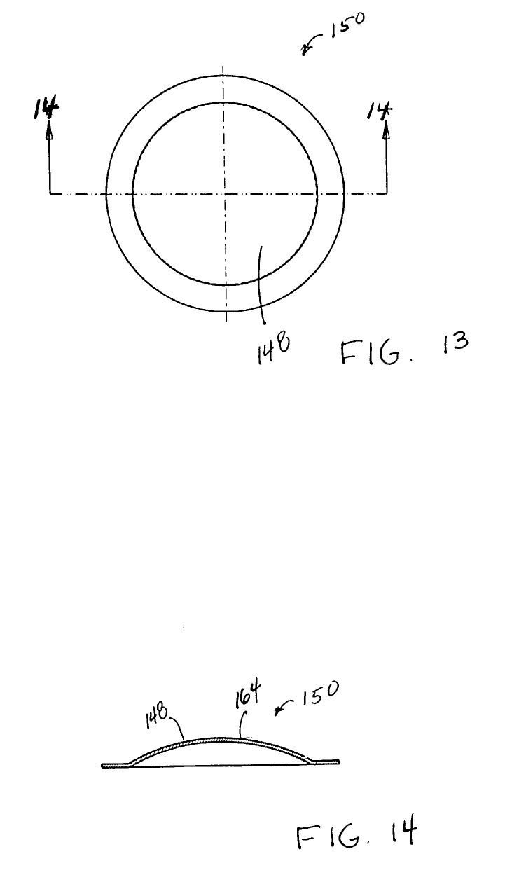

FIGS. 13 and 14 illustrate the lid 150 in further detail. As mentioned above, in preferred embodiments, the lid 150 includes the over-center engageable push-button 148. Preferably, the lid 150 is constructed of thin material, i.e. less than 0.02 inch thick, for example about 0.005-0.015 inch thick. Certain preferred embodiments are about 0.008-0.011 inch thick. Useable materials include, for example, natural high impact polystyrene.

Still in reference to FIGS. 13 and 14, the push-button 148 includes a dome-shaped portion 164 that is depressible in a direction toward the base housing 152, when the lid 150 is operably oriented on the base housing 152.

Attention is again directed to FIGS. 8 and 9. FIG. 8 shows the button 148 in a non-engaged position. FIG. 9 shows the button 148 in an engaged position. The dome-shaped portion 164, in FIG. 8, before actuation and before depressing, is oriented outward in a direction away from the base housing 152 (i.e., is convex relative to the base housing 152). In FIG. 9, the dome-portion is oriented in a direction toward the base housing 152 (i.e., is concave relative to the base housing 152). By depressing the button 148 when it is in the position shown in FIG. 8, the lid 158 flexes over-center such that the dome-portion 164 moves from the position in FIG. 8 oriented away from the base housing 152 to a position oriented toward the base housing 152 in FIG. 9.

Movement of the push-button 148 from the convex position of FIG. 8 to the concave position in FIG. 9 decreases the volume 146 containing the calibration fluid. This decrease in volume initiates flow and forces flow of the calibration fluid through the fluid passage 142 in the duct 158. When the first fluid reservoir 68 is operably mounted on the cartridge 26, this flow of calibration fluid from the fluid passage 142 then flows through the first fluid port 66 and into the fluid channel 54.

### F. Methods

In operation, to use the cartridge 26, the cartridge 26 is operably inserted or plugged into the analyzer device 24. The analyzer device 24 can include, for example, an IMRA blood analyzer as described above; or the analyzer device 24 can include a PORTAL blood analyzer as described above which is pluggable into monitor 28; or, the analyzer device 24 can include the device as described in U.S. Pat. No. 6,066,243 incorporated herein by reference. The body fluid, for example blood, can be withdrawn from the patient 22 in the syringe 74 and secured to the cartridge 26 at luer lock 76. This can be done either before inserting the cartridge 26 into the analyzer device 24 or afterwards, and before or after calibration.

When using the analyzer 31, the cartridge 26 is inserted or plugged into the analyzer 31 by sliding it into the cartridge receiving area 32 and making electrical contact between the conductor arrangement 58 and electrical contacts on the analyzer 31.

Selected ones of the sensors in the sensor arrangement 56 are then calibrated. To calibrate selected ones of the sensors in the sensor arrangement 56, the calibration fluid is dispensed from the first fluid reservoir 68 and into the fluid channel 54. To do this, the actuator 144 is engaged. To engage the actuator 144, the user pushes her finger against the push-button 148 and depresses the push-button 148 until the dome portion 164 flips from a position of being convex relative to the base housing 152 (FIG. 8) to a position of being concave relative to the base housing 152 (FIG. 9). That is, the push-button 148 moves over-center from its position in FIG. 8 to its position in FIG. 9. This causes the calibration fluid in the volume 146 to pass through the fluid passage 142 and through the first port 66. The force of the fluid causes the check valve 126 to move from a closed position (FIG. 5) to an open position (FIG. 6). The air pocket and back pressure in the first section 84 downstream of the second port 70 and upstream of the first port 66 prevents the calibration fluid from flowing in a direction from the first port 66 to the second port 70. The calibration fluid flows into the fluid channel 54 through the second section 86 and downstream through the third section 88.

The analyzer 31 includes the proper electronics to perform the calibration of selected ones of the sensors, including the sensors located in the first section 84. As mentioned above, the sensors in the first section 84 are not covered with calibration fluid from the first fluid reservoir 68. Selected ones of the sensors in the first section 84 may be calibrated by other means. For example, the oxygen sensor 90 is calibrated by exposure to the ambient air and through a barometer in the analyzer 31.

It should be noted that after deployment or dispensing of the calibration fluid from the first fluid reservoir 68, the push-button 148 stays in its depressed position of FIG. 9. This is useful in not creating a vacuum to draw the calibration fluid back up through the first port 66 and through the fluid passage 142. The fixed position of the push-button 148 in its depressed position does not allow for backflow of the calibration fluid.

Next, the fluid sample, in this example blood, is dispensed. The fluid sample may be dispensed from the second fluid reservoir 72 into the fluid channel 54 in order to accomplish the step of analyzing the fluid sample. This is done by, first, if the syringe 74 has not yet been mounted onto the cartridge 26, mounting the syringe 74 to the cartridge 26. Next, pushing the blood from the syringe 74 through the second port 70 and into the fluid channel 54, while preventing the blood from mixing with the calibration fluid when the fluid sample is in the fluid channel 54. To prevent the blood from mixing with the calibration fluid, when the blood is pushed from the syringe 74 in through the second port 70, the blood pushes the air pocket located in first section 84 through the fluid channel 54. Movement of the blood into the fluid channel 54 causes the check valve 126 to move from an open position (FIG. 6) into a closed position (FIG. 7). The check valve 132 oriented within the second portion 70 is opened by movement of the blood from the syringe 74 through the second port 70. The closing of the first valve 126 blocks flow of the blood from the fluid channel 54 into and through the first port 66. This prevents the blood and the calibration fluid from mixing. As the blood is forced into the channel 54, the air pocket in first section 84 moves downstream through the second section 86 and third section 88. This also urges the calibration fluid from the fluid channel 54 and into the waste chamber 82. As this happens, the blood is then allowed to cover all of the sensors in the sensor arrangement 56. The analyzer 31 then evaluates the characteristics of the blood through the sensor arrangement 56. The results are then displayed on the display 40, or integrated by way of monitor 28 into patient database 30. The calibration fluid is prevented from flowing from the fluid channel 54 through the second port 70. This is due to the check valve 132, as well as the check valve 126.

In some implementations, the fluid sample may be dispensed through the first port 66 by interchanging the first reservoir 68 and the second reservoir 72.

In some implementations, the step of calibration may take place after the step of dispensing the fluid sample and analyzing.

After the fluid sample has been analyzed, and the results provided, the caregiver can make the appropriate diagnosis and prescribe appropriate treatment to the patient 22. This entire procedure, from drawing the blood sample to receiving the results is all done in under 20 minutes, usually less than 15 minutes, and typically less than 10 minutes. As can be appreciated, this provides quick, point-of-care diagnostic information.

After the results are received, the cartridge 26 is removable from the analyzer 31. The cartridge 26 may be disposed of, if appropriate, or re-used, if appropriate.

### G. Example Cartridge

One typical cartridge 26 constructed using principles of this disclosure has a weight of less than 5 lbs, typically less than 1 lb. It has a perimeter area of not greater than 10 in², and often, not greater than 5 in². It is sized to be “handheld”; that is, it is sized to be manipulated by a human hand.

It typically will hold 100-400 micro liters of calibrant fluid. It typically holds a fluid sample of 85 micro liters to 3 milliliters, and often uses no more than 100 micro liters. The fluid channel containing the sensors will often contain no more than 50 micro liters of the fluid sample.

What is claimed is:

1. A cartridge for analysis of fluid samples; the cartridge being for use with an analyzer device; the cartridge comprising:
(a) a base structure defining a fluid channel;
(b) a sensor arrangement oriented within said fluid channel;
(c) said base structure defining a first port in fluid communication with said fluid channel;
(d) said base structure defining a second port in fluid communication with said fluid channel; and
(e) a first valve arrangement operably oriented in said base structure to selectively control fluid flow through said first port to said fluid channel.

2. A cartridge according to claim 1 further including:
(a) a first fluid reservoir in fluid communication with said first port;
(i) said first valve arrangement selectively controlling fluid flow from said first fluid reservoir into said fluid channel.

3. A cartridge according to claim 2 further including:
(a) a second fluid reservoir in fluid communication with said second port;
(i) said first valve arrangement preventing flow from said second fluid reservoir into said first fluid reservoir.

4. A cartridge according to claim 3 further including:
(a) a second valve arrangement operably oriented to selectively control fluid flow through said second port to said fluid channel and to prevent fluid flow from said first fluid reservoir into said second fluid reservoir.

5. A cartridge according to claim 4 wherein:
(a) said first valve arrangement is a check valve; and
(b) said second valve arrangement is a check valve.

6. A cartridge according to claim 3 wherein:
(a) said sensor arrangement includes at least two sensors.

7. A cartridge according to claim 6 wherein:
(a) said sensor arrangement includes no more than 20 sensors.

8. A cartridge according to claim 3 wherein:
(a) said sensor arrangement includes at least one electrochemical sensor.

9. A cartridge according to claim 3 wherein:
(a) said sensor arrangement includes at least one enzymatic sensor.

10. A cartridge according to claim 3 wherein:
(a) said sensor arrangement includes:
(i) at least one enzymatic sensor;
(ii) at least one amperometric sensor; and
(iii) at least one ion selective electrode sensor.

11. A cartridge according to claim 10 wherein:
(a) said sensor arrangement further includes at least one conductometric sensor.

12. A cartridge according to claim 3 wherein:
(a) said sensor arrangement includes at least one sensor selected from the group consisting of: pH; carbon dioxide; oxygen; sodium; calcium; potassium; hematocrit; blood urea nitrogen; chloride; glucose; lactate; and creatinine.

13. A cartridge according to claim 3 wherein:
(a) said first fluid reservoir is constructed and arranged for removably mounting on said base structure.

14. A cartridge according to claim 13 wherein:
(a) said first fluid reservoir defines a fluid passage and a fluid dispenser actuator;
(i) said actuator being constructed and arranged to initiate fluid flow from an internal volume in said first fluid reservoir and through said fluid passage and through said first port.

15. A cartridge according to claim 14 wherein:
(a) said first fluid reservoir includes a base and a lid mounted on said base;
(i) said lid including said actuator; said actuator including an over-center engageable button.

16. A cartridge according to claim 15 wherein:
(a) said over-center engageable button includes a dome-shaped portion depressible in a direction toward said base.

17. A cartridge according to claim 13 wherein:
(a) said first fluid reservoir includes calibration fluid therein.

18. A cartridge according to claim 3 wherein:
(a) said second fluid reservoir is constructed and arranged for removably mounting on said base structure.

19. A cartridge according to claim 18 wherein:
(a) said second fluid reservoir includes blood therein.

20. A cartridge according to claim 18 wherein:
(a) said second fluid reservoir includes a syringe.

21. A cartridge according to claim 3 further including:
(a) a third port in fluid communication with said fluid channel.

22. A cartridge according to claim 21 further including:
(a) a septum and duct in fluid communication with said third port.

23. A cartridge according to claim 22 wherein:
(a) said sensor arrangement includes a plurality of sensors; and
(b) said third port and said sensor arrangement is constructed and arranged to allow fluid flow through the third port into said fluid channel to provide fluid flow over only some of said sensors and disallow fluid flow over remaining sensors.

24. A cartridge according to claim 22 wherein:
(a) said sensor arrangement includes:
(i) an oxygen sensor; and
(ii) at least one of a creatinine sensor and a blood urea nitrogen sensor; and
(iii) a glucose sensor; and
(iv) at least one of a sodium sensor, pH sensor, carbon dioxide sensor, calcium sensor, potassium sensor, hematocrit sensor, chloride sensor, and lactate sensor;
(b) said oxygen sensor being downstream of said second port and upstream of said first port and said third port;
(c) said at least one of a creatinine sensor and a blood urea nitrogen sensor being: downstream of said first port and said second port; and upstream of said third port; and
(d) said glucose sensor and said at least one of a sodium sensor, pH sensor, carbon dioxide sensor, calcium sensor, potassium sensor, hematocrit sensor, chloride sensor, and lactate sensor being downstream of said first port, said second port, and said third port.

25. A cartridge according to claim 1 further including:
(a) a conductor arrangement in electrical contact with said sensor arrangement; said conductor arrangement being constructed and arranged to connect the sensor arrangement to the analyzer device, when the cartridge is mounted in the analyzer device.

26. A cartridge according to claim 1 further including:
(a) a waste chamber defined by said base structure; said waste chamber being in fluid communication with said fluid channel.

27. A cartridge for analysis of fluid samples; the cartridge being for use with an analyzer device; the cartridge comprising:
(a) a base structure defining a fluid channel;
(b) a sensor arrangement oriented within said fluid channel; said sensor arrangement including:
(i) at least one dry-stored sensor; and
(ii) at least one wet-stored sensor;
(c) said base structure defining a first port in fluid communication with said fluid channel; and
(d) said base structure defining a second port in fluid communication with said fluid channel.

28. A cartridge according to claim 27 wherein:
(a) said base structure defines a third port in fluid communication with said fluid channel.

29. A cartridge according to claim 28 wherein:
(b) said base structure and said sensor arrangement are constructed and arranged such that:
(i) said at least one dry-stored sensor is downstream of said second port and said first port and upstream of said third port; and
(ii) said at least one wet-stored sensor is downstream of said first port, said second port, and said third port.

30. A cartridge according to claim 28 wherein:
(a) said sensor arrangement further includes at least one enzymatic sensor;
(i) said at least one enzymatic sensor being downstream of said first port and said second port and upstream of said third port.

31. A cartridge according to claim 27 further including:
(a) a first check valve operably oriented with said base structure to selectively control fluid flow through said first port to said fluid channel.

32. A cartridge according to claim 31 further including:
(a) a second check valve operably oriented with said base structure to selectively control fluid flow through said second port to said fluid channel.

33. A cartridge according to claim 27 further including:
(a) a first fluid reservoir in fluid communication with said first port; said first fluid reservoir defining a fluid passage and a fluid dispenser actuator;
(i) said actuator being constructed and arranged to initiate fluid flow from an internal volume in said first fluid reservoir and through said fluid passage and through said first port.

34. A cartridge according to claim 28 wherein:
(a) said dry-stored sensor includes:
(i) at least one of: an oxygen sensor; a blood urea nitrogen sensor;
and a creatinine sensor; and
(b) said wet-stored sensor includes:
(i) a glucose sensor; and
(ii) at least one of a blood gases sensor and a blood electrolytes sensor.

35. A cartridge according to claim 34 wherein:
(a) said dry-stored sensor includes both said oxygen sensor and said at least one of a blood urea nitrogen sensor and a creatinine sensor;
(i) said oxygen sensor being downstream of said second port and upstream of said first and third ports;
(ii) said at least one of a blood urea nitrogen sensor and a creatinine sensor being downstream of said second port and said first port and upstream of said third port; and
(c) said glucose sensor and said at least one of a blood gases sensor and a blood electrolytes sensor is downstream of each of said first port, second port, and third port.

36. A cartridge for analysis of fluid samples; the cartridge being for use with an analyzer device; the cartridge comprising:
(a) a base structure defining a fluid channel;
(b) a sensor arrangement oriented within said fluid channel;
(c) said base structure defining a first port in fluid communication with said fluid channel; and
(d) a first fluid reservoir in fluid communication with said first port; said first fluid reservoir defining a fluid passage and a fluid dispenser actuator;
(i) said actuator comprising an over-center engageable button depressible to initiate fluid flow from an internal volume in said first fluid reservoir and through said fluid passage and through said first port.

37. A cartridge according to claim 36 wherein:
(a) said first fluid reservoir includes a base and a lid mounted on said base;
(i) said lid including said over-center engageable button.

38. A cartridge according to claim 37 wherein:
(a) said over-center engageable button includes a dome-shaped portion depressible in a direction toward said base.

39. A cartridge according to claim 36 wherein:
(a) said sensor arrangement includes at least one sensor selected from the group consisting of: pH; carbon dioxide; oxygen; sodium; calcium; potassium; hematocrit; blood urea nitrogen; chloride; glucose; lactate; and creatinine.

40. A cartridge according to claim 36 wherein:
(a) said sensor arrangement includes:
(i) at least one enzymatic sensor;
(ii) at least one amperometric sensor; and
(iii) at least one ion selective electrode sensor.

41. A cartridge according to claim 36 wherein:
(d) said base structure defines a second port in fluid communication with said fluid channel.

42. A method for analyzing a fluid sample; the method comprising:
(a) providing a cartridge including a plurality of sensors in a fluid channel therein; the plurality of sensors including at least one wet-stored sensor and at least one dry-stored sensor; and
(b) calibrating the sensors by dispensing a calibration fluid into the fluid channel to flow over the at least one wet-stored sensor and the at least one dry-stored sensor.

43. A method according to claim 42 further including:
(a) dispensing the fluid sample into the fluid channel to flow over each of the sensors in the plurality of sensors; and
(b) preventing the fluid sample from mixing with the calibration fluid when the fluid sample is in the fluid channel.

44. A method according to claim 43 wherein:
(a) said step of calibrating includes dispensing a calibration fluid through a first port and into the fluid channel; and
(b) said step of preventing includes blocking flow of the fluid sample from the fluid channel into and through the first port.

45. A method according to claim 43 further including:
(a) before said step of dispensing the fluid sample into the fluid channel, moving the calibration fluid from the fluid channel and into a waste chamber.

46. A method according to claim 45 wherein:
(a) said step of moving the calibration fluid includes pushing the calibration fluid with an air pocket from the fluid channel into the waste chamber.

47. A method according to claim 44 wherein:
(a) said step of dispensing includes dispensing the fluid sample through a second port and into the fluid channel; and
(b) the method further includes a step of preventing flow of the calibration fluid from the fluid channel and through the second port.

48. A method according to claim 47 wherein:
(a) said step of blocking flow of the fluid sample from the fluid channel into and through the first port includes using a first check valve in the first port to block flow; and
(b) said step of preventing flow of the calibration fluid from the fluid channel and through the second port includes using a second check valve in the second port to block flow of the calibration fluid from the fluid channel and through the second port.

49. A method according to claim 42 further including:
(a) operably orienting the cartridge into an analyzer device.

50. A method according to claim 42 wherein:
(a) said step of calibrating the sensors includes dispensing a calibration fluid into the fluid channel to flow over all of the sensors except for one of the sensors.

51. A method according to claim 50 wherein:
(a) said step of dispensing a calibration fluid into the fluid channel to flow over all of the sensors except for one of the sensors includes dispending a calibration fluid into the fluid channel to flow over all of the sensors except for an oxygen sensor.

52. A method for analyzing a fluid sample; the method comprising:
(a) providing a cartridge including a plurality of sensors in a fluid channel therein; and
(b) depressing an over-center button to force calibration fluid from a calibration fluid reservoir and into the fluid channel to flow over at least selected ones of the sensors.

53. A method for analyzing a fluid sample; the method comprising:
(a) providing a cartridge including a plurality of sensors in a fluid channel therein; the plurality of sensors including at least one wet-stored sensor and at least one dry-stored sensor;
(b) calibrating the plurality of sensors by:
(i) dispensing a calibration fluid into the fluid channel to flow over the at least one wet-stored sensor; and
(ii) preventing flow of calibration fluid over the at least one dry-stored sensor and exposing the at least one dry-stored sensor to ambient air.

54. A method according to claim 53 wherein:
(a) said step of providing a cartridge includes providing a cartridge having at least a first dry-stored sensor and a second dry-stored sensor; and
(b) said step of calibrating includes dispensing calibration fluid into the fluid channel to flow over one of the first and second dry-stored sensors and preventing flow of the calibration fluid over the other of the first and second dry-stored sensors.

55. A method according to claim 54 further including:
(a) dispensing the fluid sample into the fluid channel to flow over each of the sensors in the plurality of sensors; and
(b) preventing the fluid sample from mixing with the calibration fluid when the fluid sample is in the fluid channel.

56. A method according to claim 55 wherein:
(a) said step of calibrating includes dispensing a calibration fluid through a first port and into the fluid channel; and
(b) said step of dispensing the fluid sample includes dispensing the fluid sample through a second port and into the fluid channel.
